(19) United States
(12) Patent Application Publication
(10) Pub. No.: US 2026/0103258 A1
(43) Pub. Date: Apr. 16, 2026

(54) SEATED SELF-BALANCING VEHICLE

(71) Applicant: Hunter Morgenstern, Los Angeles, CA (US)

(72) Inventor: Hunter Morgenstern, Los Angeles, CA (US)

(21) Appl. No.: 18/914,763

(22) Filed: Oct. 14, 2024

(51) Int. Cl. B62K 5/027; B62K 5/06

(52) U.S. Cl. CPC B62K 5/027; B62K 5/06

(57) ABSTRACT

A self-balancing seated vehicle. A foot rest and a back rest are connected to a vehicle chassis. A self-balancing drive wheel is rotatably connected to the chassis. A power source for providing power to the drive wheel is also connected to the chassis. In a preferred embodiment, two rear wheels are each connected to the self-balancing seated vehicle via a rear wheel support bar and shock absorber.

The present invention relates to vehicles, and in particular to, self-balancing electric vehicles.

### BACKGROUND OF THE INVENTION

Prior art self-balancing mobile vehicles are known. However, they tend to be difficult to operate and are intimidating for many people.

One wheeled electric skateboards are known. A one wheeled electric skateboard includes a self-balancing drive wheel. The one wheeled electric skateboard is a self-balancing electric skateboard that has just one tire and that uses sensors, programming and gyroscopes to control a brushless electric motor to keep riders balanced and moving. Riders place their feet on either side of the tire to face sideways, leaning forward to accelerate and leaning backward to slow down. An exemplary example of a one wheeled electric skateboard is the Onewheel GT S Series one wheeled electric skateboard (Model No. OW2-00010-13) available from Future Motion, Inc. in Santa Cruz, CA and may be purchased at onewheel.com.

A one wheeled electric skateboard includes a single wheel containing a brushless electric motor that spins to propel the rider forwards or backwards making constant small adjustments to keep the rider balanced. Each board has three internal accelerometers and gyroscopes that continuously measure the orientation of the board in space. These monitors take readings approximately 14,000 times per second in order to tell the motor what to do to help the rider balance and move.

Inertial Measurement Units (IMU) are known. An IMU is a device that can be used to help a vehicle maintain balance by measuring the vehicle's acceleration, rotation, and orientation. IMUs use accelerometers and gyroscopes to measure a vehicle's acceleration and rotation rates, and magnetometers to determine the vehicle's orientation. IMUs can be used in vehicles to accurately measure and compensate for vibration and motion, even in challenging conditions. They can also be used to monitor road conditions and traffic.

What is needed is a self-balancing vehicle that allows the operator to sit and that is easy to operate and efficient.

### SUMMARY OF THE INVENTION

The present invention provides a self-balancing seated vehicle. A foot rest and a back rest are connected to a vehicle chassis. A self-balancing drive wheel is rotatably connected to the chassis. A power source for providing power to the drive wheel is also connected to the chassis. In a preferred embodiment, two rear wheels are each connected to the self-balancing seated vehicle via a rear wheel support bar and shock absorber.

### BRIEF DESCRIPTION OF THE DRAWINGS

FIG. 1-3 show a preferred embodiment of the present invention.

FIG. 4 shows a preferred electrical connectivity diagram for the present invention.

FIG. 5-6 show the operation of a preferred tilt throttle.

FIG. 7 shows an operator utilizing the present invention.

FIG. 8 shows a side view of a preferred balanced self-balancing seated vehicle.

FIG. 9-11 show a collapsing self-balancing seated vehicle.

### DETAILED DESCRIPTION OF THE PREFERRED EMBODIMENTS

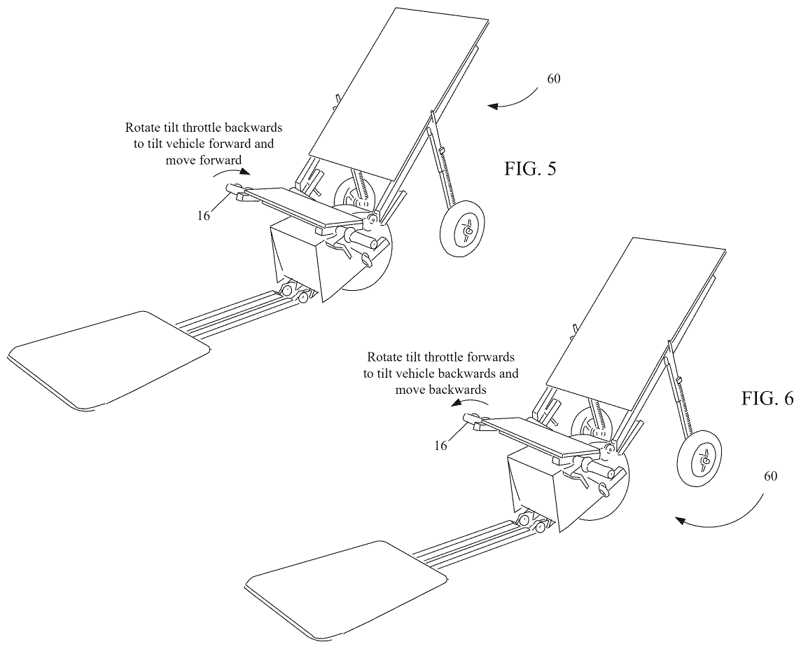

FIG. 7 shows an operator utilizing vehicle 60. Vehicle 60 is a seated, self-balancing vehicle that allows an operator to freely move in all directions while seated. Vehicle 60 is very safe to operate and provides for efficient and enjoyable transportation.

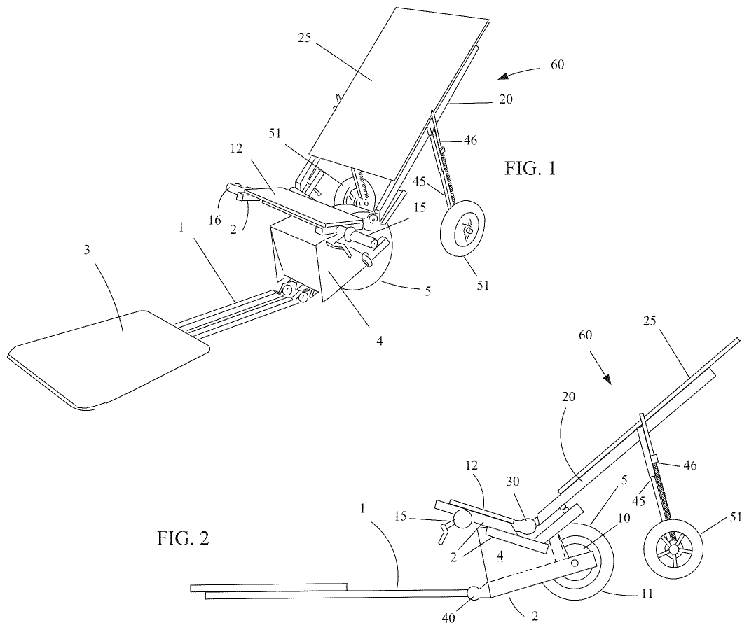

FIGS. 1-3 show a preferred embodiment of the present invention. Foot rest 3 is rigidly connected to foot rest support bars 1. Foot rest support bars 1 are pivotally connected to chassis 2 at lockable pivot connection 40. Battery box 4 is rigidly connected to chassis 2. Wheel 5 is rotatably connected to chassis 2. In a preferred embodiment, wheel 5 is the wheel described in the Background section that is used for the Onewheel GT S Series one wheeled electric skateboard (Model No. OW2-00010-13). Wheel 5 includes brushless wireless motor 10 and inflatable tire 11. Tilt throttle 16 and digital brake 15 are both rigidly connected to chassis 2. Seat 12 is rigidly connected to chassis 2. Back rest support bars 20 are pivotally connected to chassis 2 at lockable pivot connection 30. Back rest 25 is rigidly connected to back rest support bars 20. Collapsible rear wheel support bars 45 are connected to back rest support bars 20 via a lockable pivot connection. Rear wheel linear shock absorber 46 is connected between rear wheel 51 and support bars 20. In a preferred embodiment, shock absorbers 46 allow for up to 6 inches of linear shock absorption.

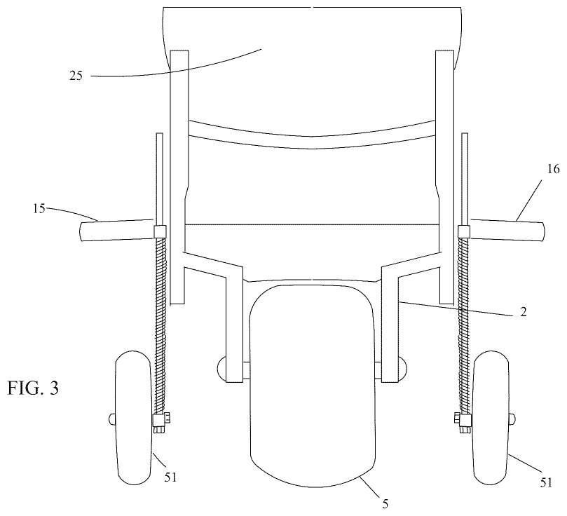

Battery box 4 (FIG. 4) includes programmable controller 70 Inertial Measurement Unit 71, battery 27 and battery management system 73. Battery 72 may be charged by connecting to normal home AC power source. The management and control of battery 72 is achieved by utilization of battery management system 73. Battery 72 is the power source for brushless DC motor 10 of wheel 5 and provides power to programmable controller 72. IMU 71 is mounted inside battery box 4. IMU 71 provides feedback data to controller 70 that represents the operator's body movements as he is operating seated electric balance vehicle 60.

Digital brake 15 is electrically connected to programmable controller 70. Digital brake 15 operates as a brake by regulating the flow of power to wheel 5. A preferred digital brake 15 is available from Yongkang Yucheng Hardware Products Factory, with offices in China (part no. SCBS).

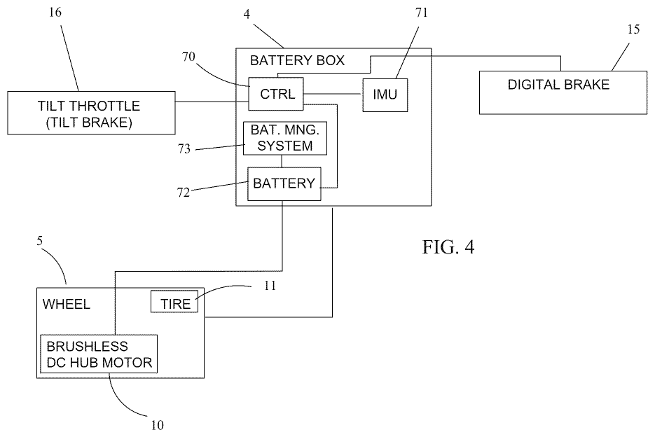

Tilt throttle 16 is electronically connected to programmable controller 70. Tilt throttle 16 is rotatable about a central axis. The operator may rotate tilt throttle 16 forward to rotate vehicle 60 forward and move forward and may rotate tilt throttle 16 rearward to tilt vehicle 60 rearward and move rearward (FIGS. 5 and 6). Tilt throttle 16 may also be controlled by the operator to act as a brake. For example, when moving forward the operator may tilt throttle 16 rearward. This will cause vehicle 60 to tilt rearward, thereby slowing down and stopping vehicle 60. A preferred tilt throttle 16 is available from Wuxing Jingbaoyuan Accessories Firm with offices in Zhejiang, China (part no. 170X).

### Utilization of the Seated Vehicle

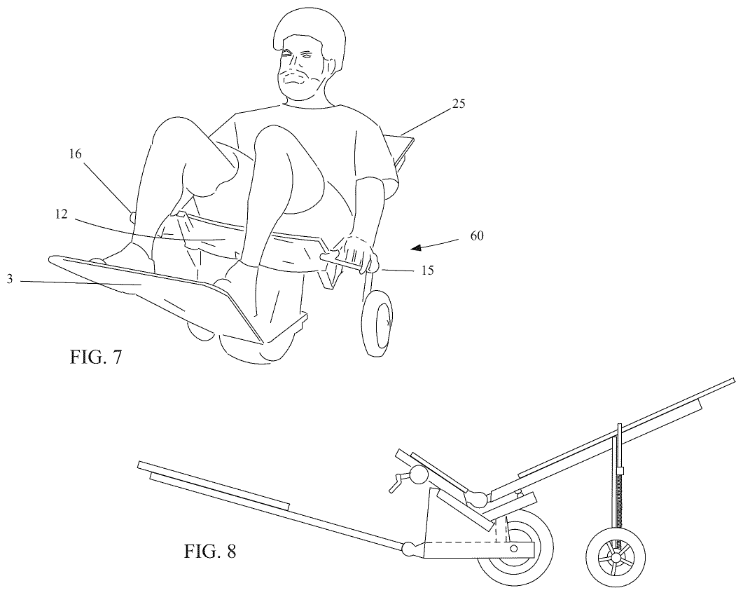

In FIG. 7, the operator of vehicle 60 has sat down onto seat 12. The operator's back is resting against back rest 25 and his feet are resting on foot rest 3. The operator is gripping digital brake 15 and tilt throttle 16. After the operator is seated, programmable controller 70 has been programmed to balance the operator by sending a control signal to hub motor 10. Bottom section 2a of chassis 2 goes to a horizontal balance position (FIG. 8), causing the operator to recline backwards (FIG. 7).

The operator may now easily move forwards, backwards, and turn left or right.

For example, to move forward the operator can lean forwards. This will cause IMU 71 to send a signal to controller 70, which then sends a control signal to hub motor 10 to rotate wheel 5 to move vehicle 60 forwards while still balancing vehicle 60. Also, to more precisely and easily move vehicle 60 forward, as explained above the user may rotate tilt throttle 16 backwards to rotate vehicle 60 forward and move forward. When tilt throttle 16 is rotated, a signal is sent from throttle 16 to controller 70, which then sends a control signal to hub motor 10 to rotate wheel 5 to move vehicle 60 forwards. Also, the user may simultaneously lean forward and rotate tilt throttle backwards to move forward.

The user may move vehicle 60 backwards in a similar fashion. For example, to move backwards the operator can lean backwards. This will cause IMU 71 to send a signal to controller 70, which then sends a control signal to hub motor 10 to rotate wheel 5 to move vehicle 60 backwards while still balancing vehicle 60. Also, to more precisely and easily move vehicle 60 backwards, as explained above the user may rotate tilt throttle 16 forwards to rotate vehicle 60 backwards and move backwards. When tilt throttle 16 is rotated, a signal is sent from throttle 16 to controller 70, which then sends a control signal to hub motor 10 to rotate wheel 5 to move vehicle 60 backwards. Also, the user may simultaneously lean backward and rotate tilt throttle forwards to move backward.

The operator may lean left or right to turn vehicle 60 left or right. When the operator leans left, his center of gravity shifts to the left side of the vehicle, causing vehicle 60 to naturally turn left due to the dynamics of balance on a single wheel. IMU 71 detects this shift in balance and sends a signal to controller 70, which adjusts the power supply to hub motor 10 to maintain the upright position of vehicle 60 while allowing the turn to occur. Similarly, leaning right shifts the center of gravity to the right, causing the vehicle to turn right, with IMU 71 and controller 70 adjusting power to hub motor 10 to maintain balance during the turn.

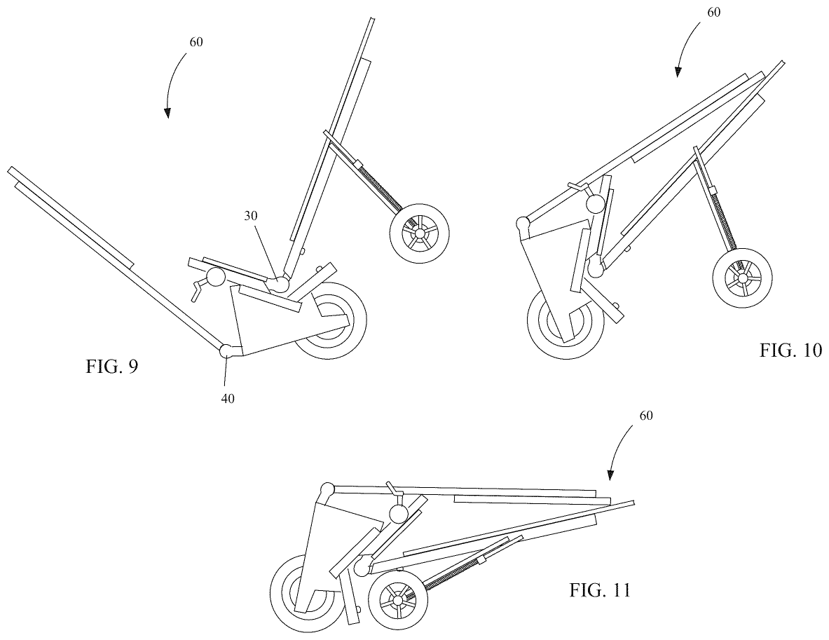

In a preferred embodiment, vehicle 60 is collapsible so that is can be more easily stored and transported. For example, FIG. 9 shows a side view of vehicle 60 partially collapsed. Foot rest 3 is being pivoted clockwise about lockable pivot connection 40 and back rest 25 is being pivoted counterclockwise about lockable pivot connection 40. In FIG. 10, Foot rest 3 and back rest 25 have been fully pivoted to the position shown. In FIG. 11 rear wheel support bars have been pivoted clockwise so that now vehicle 60 is now ready for easy storage and transport.

Although the above preferred embodiments have been described with specificity, persons skilled in this art will recognize that many changes to the specific embodiments disclosed above could be made without departing from the spirit of the invention. Therefore, the attached claims and their legal equivalents should determine the scope of the invention.

What is claimed is:

1. A self-balancing seated vehicle, comprising:
A. a chassis,
B. a foot rest connected to said chassis,
C. a back rest connected to said chassis,
D. a self-balancing drive wheel rotatably connected to said chassis, and
E. a power source connected to said chassis, said power source electrically connected to said drive wheel.

2. The self-balancing seated vehicle as in claim 1, wherein said foot rest is pivotally connected to said chassis.

3. The self-balancing seated vehicle as in claim 1, wherein said back rest is pivotally connected to said chassis.

4. The self-balancing seated vehicle as in claim 1, wherein said self-balancing vehicle is collapsible for easy storage and transportation.

5. The self-balancing seated vehicle as in claim 1, further comprising at least one rear support wheel connected to said back rest via a shock absorber.

6. The self-balancing seated vehicle as in claim 1, further comprising a hand-operated tilt throttle.

7. The self-balancing seated vehicle as in claim 1, further comprising a hand-operated digital brake.

8. The self-balancing seated vehicle as in claim 1, wherein said self-balancing drive wheel comprises a brushless dc hub motor and a tire.

9. The self-balancing seated vehicle as in claim 1, further comprising;
A. a programmable controller
B. a hand-operated tilt throttle providing signal inputs to said programmable controller,
C. a hand-operated digital brake providing signal inputs to said programmable controller, and
D. an inertial measurement unit providing signal inputs to said programmable controller,
wherein said programmable controller is electrically connected to said self-balancing drive wheel to provide control signals to said self-balancing drive wheel.

10. The self-balancing seated vehicle as in claim 1, further comprising a rechargeable battery for providing power.

11. The self-balancing seated vehicle as in claim 6, wherein said tilt throttle is rotated backwards to move forward and said tilt-throttle is rotated forwards to move backwards.

12. The self-balancing seated vehicle as in claim 1, wherein said power source is a rechargeable battery.

13. The self-balancing seated vehicle as in claim 1, further comprising two pivotally connected rear wheel support bars each comprising a rear wheel, wherein a shock absorber is connected between said rear wheel and said back rest.
